(19) United States
(12) Patent Application Publication
(10) Pub. No.: US 2016/0065456 A1
(43) Pub. Date: Mar. 3, 2016

(54) SYSTEM AND METHOD PROVIDING SERVICE CHAINING IN A MOBILE NETWORK

(71) Applicants: PRAVEEN VASANT MULEY, CUPERTINO, CA (US); WIM HENDERICKX, WESTERLO (BE); LAURENT THIEBAUT, ANTONY (FR)

(72) Inventors: PRAVEEN VASANT MULEY, CUPERTINO, CA (US); WIM HENDERICKX, WESTERLO (BE); LAURENT THIEBAUT, ANTONY (FR)

(73) Assignees: ALCATEL LUCENT, BOULOGNE-BILLANCOURT (FR); ALCATEL-LUCENT USA INC., MURRAY HILL, NJ (US)

(21) Appl. No.: 14/541,342

(22) Filed: Nov. 14, 2014

Related U.S. Application Data
(60) Provisional application No. 62/045,407, filed on Sep. 3, 2014.

(51) Int. Cl. H04L 12/721; H04L 12/851; H04M 15/00

(52) U.S. Cl. CPC H04L 45/38; H04M 15/66; H04L 47/2441

(57) ABSTRACT

Methods, systems and apparatus for associating packets or traffic flows with service functions to be applied thereto such that repeated identification of the packets or traffic flows at each of multiple service delivery modules may be avoided.

### CROSS-REFERENCE TO RELATED APPLICATIONS

This application claims the benefit of U.S. Provisional Patent Application Ser. No. 62/045,407, filed on Sep. 3, 2014, entitled SYSTEM AND METHOD PROVIDING SERVICE CHAINING IN A MOBILE NETWORK, which application is incorporated herein by reference.

### TECHNICAL FIELD

The invention relates generally to managing network resources and, more specifically but not exclusively, to efficiently applying one or more service functions to packets or data flows at a Policy Control Enforcement Function (PCEF).

### BACKGROUND

Existing networks are typically configured to apply network services (e.g., firewall services, network address translation (NAT) services, virus scanning services and the like) to IP packets or traffic flows such as service data flows (SDFs) and application flows (AFs) received at a network element. For example, a Wireless Access Point (WAP), Service Gateway (SGW), Packet Data Network (PDN) Gateway (PGW) or other network element may require that all various network services be applied to all received traffic. These network services are often implemented via multiple specialized devices or servers at different physical or logical locations in the network, where each specialized device or server performs deep packet inspection (DPI) to identify received IP packets or traffic flows and determine the appropriate network services and/or service parameters to be applied.

Network service chaining provides a mechanism whereby a network operator or other entity may identify specific network services to be applied to different types of traffic flows moving through the network (such as email, streaming video, UMTS, SIP etc.) and routes these traffic flows through the specialized devices or servers configured to apply the appropriate service. However, repeated classification of traffic flows (e.g., via deep packet inspection (DPI)) may still be necessary at each of the specialized devices or servers implementing the network services.

### SUMMARY

Various deficiencies of the prior art are addressed by the present invention of method, apparatus and system for efficiently processing IP packets or traffic flows according to various network services. Various embodiments contemplate associating packets or traffic flows with service functions to be applied thereto such that repeated identification of the packets or traffic flows at each of multiple service delivery modules may be avoided.

Various embodiments contemplate mapping a flow classifier as a Traffic Detection Function (TDF) identifier. Various embodiments further contemplate extending a policy interface to communicate policy rules with services that need to be applied to classified packets or data flows. Various embodiments further contemplate extending a charging interface to provide user charging prior to or contemporaneous with processing of packets or traffic flows as described herein.

### BRIEF DESCRIPTION OF THE DRAWING

The teachings of the present invention can be readily understood by considering the following detailed description in conjunction with the accompanying drawings, in which:

FIG. 1 depicts a high-level block diagram of a system benefiting from various embodiments;

FIG. 2 depicts a flow diagram of methods according to various embodiments;

FIG. 3 depicts a simplified block diagram of a portion of the mobile network of FIG. 1; and

FIG. 4 depicts a high-level block diagram of a general purpose computing device suitable for use in various embodiments.

To facilitate understanding, identical reference numerals have been used, where possible, to designate identical elements that are common to the figures.

### DETAILED DESCRIPTION

Various deficiencies of the prior art are addressed by the present invention of method, apparatus and system for efficiently processing IP packets or traffic flows according to various network services. Various embodiments contemplate mapping a flow classifier as a Traffic Detection Function (TDF) identifier. Various embodiments further contemplate extending a policy interface to communicate policy rules with services that need to be applied to classified packets or data flows. Various embodiments further contemplate extending a charging interface to provide user charging prior to or contemporaneous with processing of packets or traffic flows as described herein.

The invention will be primarily described within the context of a policy-based mechanism operable at a gateway device such as a Service Gateway (SGW), a Packet Gateway (PGW) or other provider equipment (PE) to identify received packets or traffic flows, determine appropriate network processing services to be applied to the received packets or traffic flows, adapt the received packets or traffic flows to include metadata indicative of the network processing services to be applied, and forward the adapted received packets or traffic flows toward service data equipment (SDE) or modules for network services processing in accordance with the metadata.

Generally speaking, various embodiments provide a mechanism for maintaining an existing UE control session attachment while changing UE data session bearers, such data bearers of different IP Connectivity Access Networks (IP-CANs).

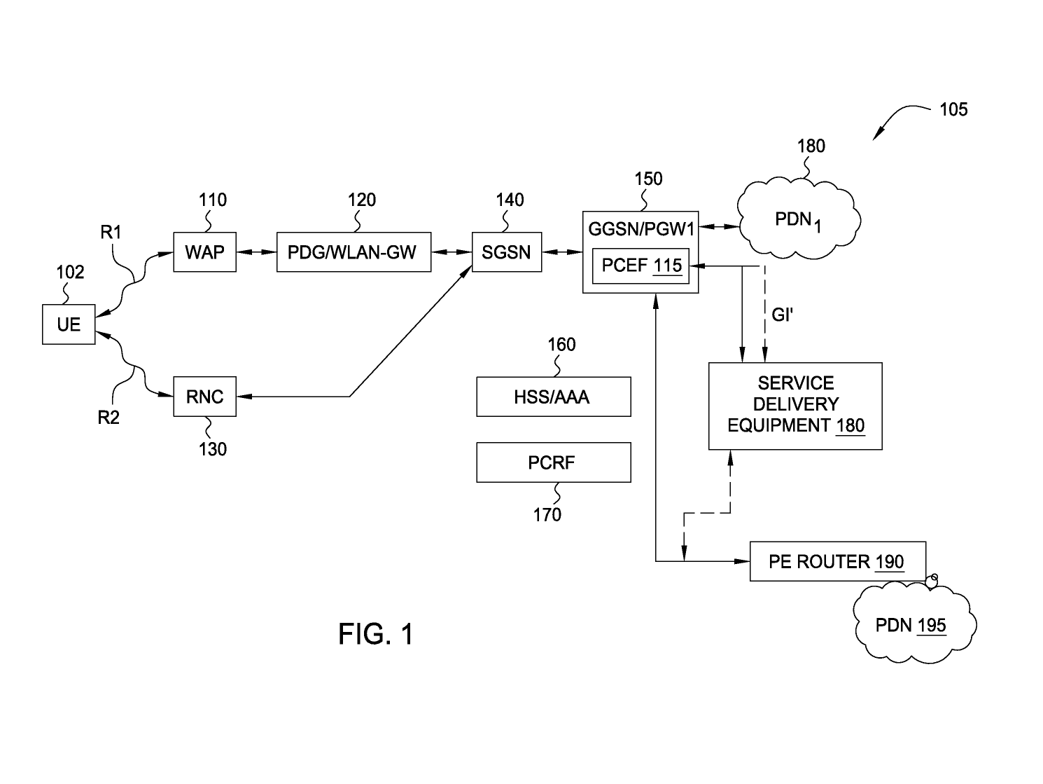

FIG. 1 depicts a high-level block diagram of a system benefiting from various embodiments. The system 100 of FIG. 1 comprises, illustratively, user equipment (UE) 102, Wireless Access Point (WAP) 110, Packet Data Gateway (PDG)/Wireless LAN gateway (WLAN-GW) 120, Serving GPRS Support Node (SGSN) 140, Gateway GPRS Support Node (GGSN)/Packet Gateway (PGW) 150, Home Subscriber Server (HSS)/Authentication, Authorization and Accounting (AAA) server 160, Mobility Management Entity (MME) 165, Policy and Charging Rules Function (PCRF) 170, service delivery equipment (SDE) 180, a provider equipment (PE) router 190 as well as various other network elements (not shown) supporting control plane and/or data plane operations.

The UE 102 may comprise a smart phone, tablet computer, laptop computer, set top box (STB) or any other wireless or wireline device capable of receiving packets or traffic flows such as associated with Service Data Flows (SDFs), Application Flows (AFs), mobile services, voice communications, electronic mail, messages and/or types of data. Various embodiments contemplate different types of UE 102, such as UE capable of accessing a mobile network directly via a Radio Network Controller (RNC) and/or via a wireless access point (WAP). The mobile network may comprise a 3G/4G mobile network such as a 3GPP network, Universal Mobile Telecommunications System (UMTS) network, long-term evolution (LTE) network and so on. The WAP may be associated with a Wi-Fi, WiMAX or other wireless access network. It will be noted that while only one UE is depicted, large numbers of UE may also be used.

The SGSN 140 and GGSN/PGW 150 are depicted as providing SDFs, AFs, mobile services, voice communications, electronic mail, messages and/or other types of data packets or traffic to the one or more UEs 102. Generally speaking, UE 102 communicates with WAP 110 and/or RNC 130 to receive packets or traffic flows thereby. The WAP 110 is depicted as communicating with the GGSN/PGW 150 via a bearer link such as a tunnel such as a GPRS Tunneling Protocol (GTP) tunnel through the PDG/WLAN-GW 120 and SGSN 140. The RNC 130 is depicted as communicating with the GGSN/PGW 150 via a bearer link such as a tunnel through the SGSN 140.

The MME 165 provides mobility management functions in support of mobility of UEs 102. The MME 165 supports the RNC 130 and SGSN 140. The MME 165 provides various functions as is known, such as selecting a particular SGSN for a UE at a time of initial attachment by the UE or during UE handover operations, providing idle-mode UE tracking and paging procedures, bearer activation/deactivation processes, providing support for Non-Access Stratum (NAS) signaling (e.g., terminating NAS signaling, ciphering/integrity protection for NAS signaling, and the like), lawful interception of signaling, and the like, as well as combinations thereof. The MME 165 also may communicate with the Home Subscriber Server (HSS) 160 to authenticate users.

The PCRF 170 provides dynamic management capabilities by which a service provider may manage rules related to services provided via the mobile network, as well as rules related to charging for services provided via the mobile network. For example, rules related to services provided via the mobile network include rules for bearer control (e.g., controlling acceptance, rejection, and termination of bearers, controlling QoS for bearers, and the like), service flow control (e.g., controlling acceptance, rejection, and termination of service flows, controlling QoS for service flows, and the like), and the like, as well as combinations thereof. For example, rules related to charging for services provided via the mobile network may include rules related to online charging (e.g., time-based charging, volume-based charging, event-based charging, and the like, which may depend on factors such as the type of service for which charging is being provided), offline charging (e.g., such as for checking subscriber balances before services are provided and other associated functions), and the like, as well as combinations thereof.

The PCRF 170 communicates with PGW 150 to transfer rules from the PCRF 170 to a Policy and Charging Enforcement Function (PCEF) 155 supported by PGW 150, which provides enforcement of the policy and charging rules specified on PCRF 170.

In various embodiments, GGSN/PGW 150 transmits and receives public network traffic via a public interface Gi. The public interface Gi is used to communicate with public data networks 195 via provider edge (PE) equipment 190 such as an edge router coupled to the Internet or other public network.

The PGW/GGSN 150 may be configured to provide a policy control enforcement function (PCEF) 155 for processing public network traffic or other traffic. For example, public network traffic comprising IP packets or traffic flows may be identified by the PCEF and subjected to one or more network services prior to forwarding the IP packets or traffic flows towards UEs 102 or other network elements. While primarily described within the context of implementation within the PGW/GGSN 150, it will be appreciated that the PCEF 150 may be implemented by various network elements, including one or more of PE router 190, PGW/GGSN 150, SGSN 140, PDG/WLAN-GW 120, WAP 110 and/or RNC 130.

A packet or traffic flow identified by the PCEF may comprise a Services Data Flow (SDF) such as a SIP flow, UMTS flow, TCP flow or other SDF, an Application Flow (AF) such as associated with a IP telephony application (e.g., Skype), streaming media application (e.g., Netflix), a secure network session (e.g., an IP-Sec session) or other AF, or some other data (e.g., email, file transfer, messaging and the like).

Network services applied to a packet or traffic flow may comprise one or more of deep packet inspection (DPI), firewall processing, natural address translation (NAT), parental control or content filtering, wireless scanning, security services and various other network services known to those skilled in the art.

In various embodiments, the PCEF 155 cooperates with service delivery equipment (SDE) or modules 180 to apply the appropriate network services to received public network traffic. The SDE 180 may comprise virtual, non-virtual or a combination of virtual and non-virtual devices or servers, a services “farm” adapted to applying network services and so on. Various embodiments contemplate a virtual services farm instantiated within the context of a data center (DC) and cooperating with virtual entities implementing a PCEF or otherwise requiring the application of network services to packets or traffic flows within the received public network traffic. The services farm may comprise a separate network entity such as a server or other device or appliance configured to process packets according to one or more services. Connectivity between the PCEF 155 and SDE 180 may be provided via a VxLAN tunnel into the data-center.

In various embodiments, some or all public traffic received by the PGW/GGSN 150 from the PE router 190 (e.g., inbound traffic received via the Gi interface) is processed by the PCEF 155 to identify specific packets or traffic flows requiring further processing according to various network services. The identified packets or traffic flows are forwarded to SDE 180 for such processing, and then returned by the SDE 180 to the PGW/GGSN 150 for subsequent transmission toward destination network elements (e.g., UE 102).

In various embodiments, the PE router 190 implements a PCEF such as described herein and forwards public traffic to the PGW/GGSN 150 via the SDE 180. Specifically, the PCEF of the PE router 190 identifies within public traffic destined for the PGW/GGSN 150 specific packets or traffic flows requiring further processing according to various network services. The identified packets or traffic flows are forwarded to SDE 180 for such processing and subsequent forwarding to the PGW/GGSN 150 by the SDE 180.

In various embodiments, some or all traffic transmitted by the PGW/GGSN toward the PE equipment (e.g., outbound traffic transmitted via the Gi interface) is processed by the PCEF 155 to identify specific packets or traffic flows requiring further processing according to various network services. The identified packets or traffic flows are forwarded to SDE 180 for such processing, and then returned by the SDE 180 to the PGW/GGSN 150 for subsequent transmission toward the PE router 190. In various embodiments, the outbound packets or traffic flows processed by the SDE 180 are forwarded by the SDE 180 directly to the PE router 190.

In various embodiments, the operation of the PCEF may be adapted by policy information received from a Policy and Charging Rules Function (PCRF). For example, a policy server or other entity (e.g., PCRF 170) may be used to express policies defining specific network services to be applied to a given flow based upon flow type or other criteria. That is, the PCEF identifies the type of each received packet or traffic flow so that a determination may be made as to the specific network services to be applied to the identified packet or traffic flow. In this manner, a policy-driven application of specific network services to specific types of packets or traffic flows may be implemented.

For example, the PCEF 155 (or other PCEF implemented in accordance with the various embodiments) communicates with the PCRF 170 to receive policy-based information indicative of, for example, the network services to be applied to different types of packets or traffic flows.

In various embodiments, the PCEF adapts a Traffic Data Flow (TDF) identifier of each packet or traffic flow to include data indicative of the service functions to be applied to the packet or traffic flow and, optionally, the order in which the service functions are to be applied. In particular, TDF identifiers normally associated with the packets or traffic flows are further utilized by the service chain architecture to communicate the identified packet or traffic flow type. In this manner, if the there is any policy applied as a Service Function (SF) such as the PCEF, the SF may use the TDF identifier construct in formulating a definition of the policy rule. Further, the SF may utilize a Sd interface to download any policy from, illustratively, the PCRF 170, wherein the policy provided via the Sd interface for a respective application (or other data type) is expressed via the TDF identifiers.

Various embodiments contemplate several PCRF extensions for implementing the various functions described herein. For example, within the context of creating a session between network element implementing the PCEF and PCRF, the various service functions applicable to the relevant IP Connectivity Access Network (IP-CAN) sessions may be communicated by one or both of a Service Function Name Reference (SFNR) or Network Service Function (NSC).

The SFNR may comprise a preconfigured list of network services or identification of a network service chain which can be communicated via, illustratively, a NSC header within a data plane packet wherein each network service is identified via a respective 4-bit, 8-bit or other value.

Further, various embodiments contemplate the service function name may be configured to identify one or both of an ingress network service chain (INSC) and an egress network service chain (ENSC), each of which is marked in response to packet direction match. That is, outbound packets (e.g., those being routed toward an egress node such as PE router 190), are associated with an ENSC while inbound packets (e.g., those being received via an ingress node such as PE router 190) are associated with a INSC.

The Network Service Function (NSF) may comprise a service chain grouped AVP, which may optionally have sub-AVPs, defining the Network Service Identifier, Network Service Position and Network Service Direction. This can help in building a service chain and provide a reference by which to traverse a service order (i.e., defining a sequence or order of applying network services). Various information elements described herein may be passed through a NSC context header, which is especially useful applying network services where applications derive actions to be taken with respect to a packet by inspecting the header of the packet.

In various embodiments, the NSC header carries a flow classifier (e.g., TDF identifier) in the NSC header which is used by network services provider equipment to apply to the packet or flow those service policies matching the TDF identifier.

Various embodiments provide a Policy Control and Charging (PCC) functionality with integrated Application Detection and Control (ADC) rules which, advantageously, provide a mechanism for using charging information typically received with TDF identifiers. For example, various embodiments contemplate extending various PCC functions, such as extending “TDF+charging” to “TDF+(Network Service Identifier+charging)”, “TDF+((NSI+RG+SVC)”, “TDF+(NSI′+RG′+SVC′)”, . . . ) In this manner, accounting functions may be enabled for each network service.

Thus, various embodiments provide a policy-driven mechanism for efficiently applying specific network services to identify IP packets or traffic flows via a PCEF. Various embodiments contemplate a mechanism for identifying received IP packets or traffic flows, determining the appropriate network services to be applied to the IP packets or traffic flows as defined by one or more policies, adapting metadata associated with the IP packets or traffic flows to indicate packet/flow type, network services to be applied, sequence of applying network services and/or other information. The metadata may comprise a Network Service Chain (NSC) indicator.

Various embodiments contemplate implementation within a virtualized environment such as a data center, wherein a PCEF or other entity performs deep packet inspection (DPI) upon received traffic to identify traffic flows therein, determine the network services to be applied to each identified traffic flow, optionally tag or mark each identified traffic flow with meta data indicative of the determined network services, and forward each traffic flow toward one or more entities configured to apply the determined network services to the traffic flow. Advantageously, these embodiments perform deep packet inspection only once for each traffic flow.

In many networks the PCEF (GGSN/PGW) is separate from the PE. As such, network services are applied while sending the packet from the PCEF to PE in the ingress direction and PE to PCEF in the egress direction. Since the services are common for given Access Point Name (APN) or group of subscribers, the packets may be put into a service chain using either DSCP or VLAN.

Advantageously, rather than charging a user each time a network service is performed on a user packet or traffic flow, by knowing those network services to be performed as indicated by service chain data, the user may be charged for those network services prior to actual application of the network services upon the packet or traffic flow associated with the user.

For example, since the services to be applied to two received or ingress packets or traffic flows are known, the user may be charged for application of these known services prior to or contemporaneous with sending the inbound packet to the service chain for ingress service chain processing. Similarly, the services applied in the egress direction are also known such that the user may be charged for application of these known services prior to or contemporaneous with sending the outbound packet to the service chain for egress processing.

In various embodiments, a virtualized system is provided wherein the various network services are provided by an instantiated virtual machine (VM). In particular, a services farm is instantiated wherein the services farm performs one or more network services upon any packet or traffic flow it receives.

In various embodiments, each of a plurality of instantiated services farms applies a respective group of services to each packet or traffic flow it receives. For example, a first services farm performs network services related to email, a second services farm performs network services related to streaming video, a third services farm performs network services related to audio and so on. The PCEF function determines, via deep packet inspection or other means, the type of packet or traffic flow to be processed and forwards the packet or traffic flow to the appropriate services farm.

In various embodiments, an instantiated services farm applies network services to each packet or traffic flow it receives in accordance with a type indicator or other meta data associated with the packet or traffic flow. For example, a services farm performs network services related to email, streaming video, audio and so on in response to meta data associated with the packet or traffic flow. The PCEF function determines, via deep packet inspection or other means, the type of packet or traffic flow to be processed, adapts the packet or traffic flow to include a type indicator via meta data or other means, and forwards the packet or traffic flow to the appropriate services farm where the type indicator is used to determine the appropriate network services to be applied to the packet or traffic flow.

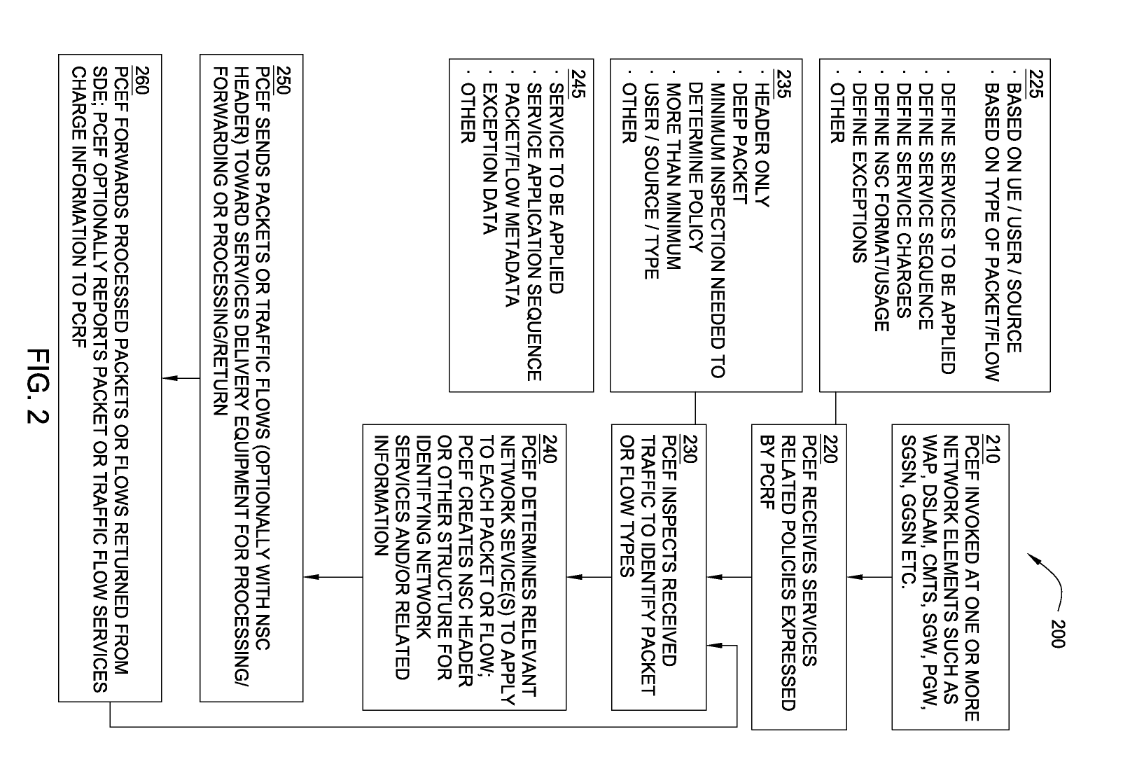

FIG. 2 depicts a method according to various embodiments. Specifically, FIG. 2 depicts a method 200 suitable for use by a PCEF mechanism (e.g., such as a PCEF implemented at GGSN/PGW 150) interacting with services delivery equipment (SDE) (such as SDE 180) as according to the various embodiments.

At step 210, a Policy Control Enforcement Function (PCEF) is invoked at one or more network elements, such as a Wireless Access Point (WAP), DSLAM, CMTS, Service Gateway (SGW), Packet Gateway (PGW), SGSN, GGSN or other network entity. For purposes of this discussion, it will be assumed that a PCEF is invoked at a GGSN/PGW 150 in the system 100 of FIG. 1.

At step 220, the PCEF receives services related policies expressed by a PCRF, such as PCRF 170 of the system 100 of FIG. 1. The services related policies define network policies and/or network policy parameters applicable to various types of packets, traffic flows and the like received by the PCEF for processing. Referring to box 225, the services related policies may be based upon UE (e.g., type, capability or other parameter), user (e.g., type, subscriber level or other parameter), source of traffic, type of packets or traffic and so on. Further, the services related policies may defined at the services to be applied, the sequence in which the services are to be applied, any charges associated with the application of the services, format or usage data associated with Network Service Chain (NSC) indicator, any exceptions and/or any other information.

At step 230, the PCEF inspects received traffic to identify packet or flow types therein. For example, the PCEF inspects received traffic to identify Service Data Flows (SDFs), Application Flows (AFs), and/or other types of traffic flows or packets (e.g., email, undefined services or applications, types of voice traffic, types of streaming media and so on). Referring to box 235, PCEF inspection of received traffic is performed via inspecting only header portions of received packets/traffic structure, via deep packet inspection (DPI), according to a minimal inspection level necessary to determine policy application, according to a more than minimal inspection level necessary to determine policy application, by user, by source, by type or by other mechanism.

At step 240, the PCEF determines the relevant network service or services to apply to each of the packets or traffic flows identified at step 230, as well adapting the structure of identified packets or traffic flows to include therein a respective NSC indicator (e.g., a NSC header or data structure) for identifying respective network services and/or related information for use in processing the respective identified packets or traffic flows. Referring to box 245, the PCEF may determine (and indicate) specific network services to be applied, sequence of applying network services, the packet or traffic flow metadata by which to indicate packet/flow type, network services, network services sequence and the like, any exception data as well as other information.

At step 250, the PCEF transmits or directs the packets or traffic flows including network service indicative metadata toward service delivery equipment for processing/forwarding or for processing/return. In processing/forwarding embodiments, packets or traffic flows are processed by service delivery equipment according to the network service indicative metadata and then forwarded by the service delivery equipment toward the destination address. In processing/return embodiments, packets or traffic flows are processed by service delivery equipment according to the network service indicative metadata and then returned by the service delivery equipment to the PCEF.

At step 260, the PCEF forwards processed packets or traffic flows returned from the service delivery equipment. Optionally, the PCEF report packet or traffic flow services charge information to a PCRF or other management entity.

Radio Access Network Congestion Awareness Function

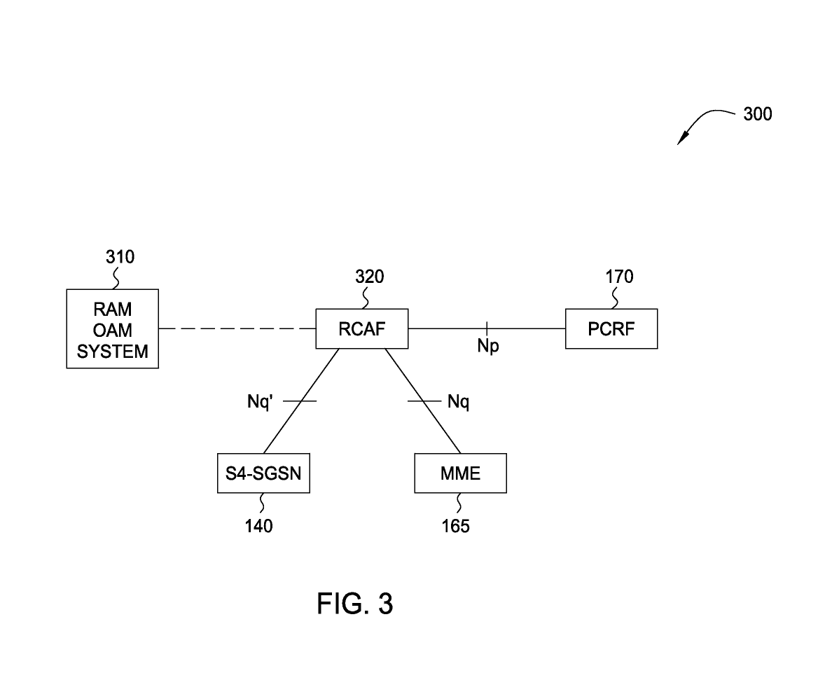

FIG. 3 depicts a simplified block diagram of a portion of the mobile network of FIG. 1, illustratively a 3G/4G mobile network such as a 3GPP network, Universal Mobile Telecommunications System (UMTS) network, long-term evolution (LTE) network and so on.

The mobile network portion 300 depicted in FIG. 3 comprises a Radio Access Network (RAN) Operations, Administration and Maintenance (OAM) system 310 communicating with a RAN Congestion Awareness Function (RCAF) 320, which communicates with the SGSN 140, MME 165 and PCRF 170.

Generally speaking, the RCAF 320 is used to provide a RAN congestion notification such as described herein. It is noted that the embodiments described with respect to the various other figures may be modified to provide a RCAF such as described herein with respect to FIG. 3.

Referring to FIG. 3, a communication path between the RCAF 320 and the MME 165 is associated with a reference point Nq, while a communication path between the RCAF 320 and the SGSN 140 is associated with a reference point Nq′. The Nq reference point enables the RCAF to monitor control plane traffic to/from the MME 165 to retrieve therefrom various information such as a list of UEs (illustratively identified by respective International Mobile Subscriber Identity IMSI) served by an eNodeB or E-UTRAN cell in communication with the MME 165. Similarly, the Nq′ reference point enables the RCAF to monitor control plane traffic to/from the SGSN 142 retrieve therefrom various information such as a list of APNs of the active PDN connections of each IMSI.

The RCAF processes some or all of the monitored control plane traffic to generate thereby RAN User Plane Congestion Information (RUPCI) suitable for use by, illustratively, the PCRF 170. It is noted that congestion information conveyed via the RUPCI is not necessarily indicative of an instantaneous congestion condition or burst; rather, the RUPCI conveyed congestion information is generally indicative of a sustained congestion condition.

The PCRF 170 may utilize the RUPCI for various purposes, such as providing congestion information useful in determining selecting policies or policy parameters for subsequent use by the PCEF 155. For example, the PCRF 170 may extract from the RUPCI available per-PDN information and forward this information to the PCEF 155. Similarly, the PCRF 170 may take various actions such as changing a group of filters from one RAT to another RAT as part of an IP Flow Mobility (IFOM) function, throttling bandwidth and/or various other traffic flow/management functions, in addition to communicating RAN congestion status.

The RUPCI may be used by PGW 150 to change or otherwise adapt local/static policies. The RUPCI may be communicated via one or both of a command level or a Policy Control and Charging (PCC) level.

In various embodiments, a new RAN congestion status data element is defined on a Gx interface and is able to communicate user plane congestion status at, illustratively, eight different severity levels. More or fewer severity levels may be utilized in different embodiments.

In various embodiments using Gi-LAN services, congestion status may also be used to determine appropriate policies to be applied. In various embodiments, RUPCI may be received via a direct Sd interface, though using the direct Sd interface may require the use of the Sd interface for all applied services which impact Gx server scaling.

In various embodiments, RUPCI is provided via a specific Network Services Header (NSH), such as defined herein. That is, a new service shared standard context header is defined to communicate RUPCI, such as defined below.

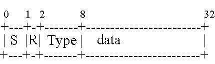

Service Shared Standard Header

### Where:

S=Standards defined header indicator (if 1 then standards defined header);

### R=Reserved;

Type=6 bit value; and
Data=contextual metadata.
An example of service shared standard header usage is provided below.

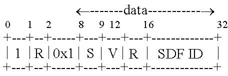

RAN Congestion Service Shared Meta-Data Header

### Where:

S=1 denoting a standards defined header;
Type=0×1 denoting a RAN congestion header; and
Data=contextual metadata representing the following:
S=8th bit;
   if S=1, then SDF specific.
   if S=0, then congestion status is PDN connection level (IMU+APN).
V=9^{th}-11^{th} bits; 3 bit value 0-8 representing congestion severity status.
R=12^{th}-16^{th} bits; 4 bit reserved.
SDF ID=17^{th}-31^{st} bits; if S=1 then specifies the SDF ID or the APP ID.

The congestion status NSH header can be used to convey information in either direction, such as PGW <-> Gi-LAN service.

The congestion status NSH may also be communicated from a Gi-LAN services towards the PGW. In various embodiments, some of the Gi-LAN services based on TCP retransmits may be used to monitor the performance of the application. This monitoring or status thereof may be communicated to PCRF by including NSH header.

PGW 150, upon receiving the congestion status NSH, may remove the header and pass the included information to a Gx server using an IP CAN session. The PCRF, using this information, may trigger actions such as an NB-IFOM event of moving a flow from a current RAT to another RAT.

In various embodiments, cell information and status information is communicated at the cell level.

In various embodiments, an ACK mechanism between the PGW and Gi-LAN service nodes/VM is implemented. In these embodiments, the ACK in itself may be provided via a context header, and/or via a RSVP ACK mechanism.

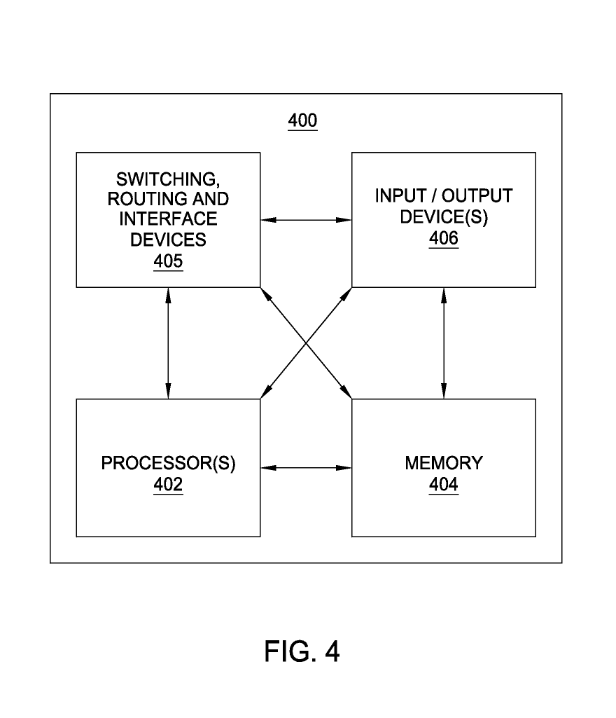

FIG. 4 depicts a high-level block diagram of a computing device, such as a processor in a telecom network element, suitable for use in performing functions described herein such as those associated with the various elements described herein with respect to the figures.

As depicted in FIG. 4, computing device 400 includes a processor element 402 (e.g., a central processing unit (CPU) and/or other suitable processor(s)), a memory 404 (e.g., random access memory (RAM), read only memory (ROM), and the like), cooperating module/process 405, and various input/output devices 406 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

In the case of a routing or switching device such as PE router 190, PGW/GGSN 150, SGSN 140, PDG/WLAN-GW 120, WAP 110, RNC 130 and the like, the cooperating module process 405 may implement various switching devices, routing devices, interface devices and so on as known to those skilled in the art. Thus, the computing device 400 is implemented within the context of such a routing or switching device (or within the context of one or more modules or sub-elements of such a device), further functions appropriate to that routing or switching device or also contemplated and these further functions are in communication with or otherwise associated with the processor 402, input-output devices 406 and memory 404 of the computing device 400 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 405 can be loaded into memory 404 and executed by processor 402 to implement the functions as discussed herein. Thus, cooperating process 405 (including associated data structures) can be stored on a computer readable storage medium, e.g., RAM memory, magnetic or optical drive or diskette, and the like.

It will be appreciated that computing device 400 depicted in FIG. 4 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various embodiments contemplate an apparatus including a processor and memory, where the processor is configured to perform various operations in accordance with the embodiment disclosed herein.

Various embodiments contemplate methods, apparatus, systems, mechanisms, network elements and the like performing procedures such as determining, by a network element receiving a plurality of packets or traffic flows, a respective service function for each of the plurality of packets or traffic flows, each service function indicative of one or more services to be applied to a respective packet or traffic flow; and adapting, by the network element, a Traffic Data Flow (TDF) identifier of each packet or traffic flow to include data indicative of the respective service function.

In various embodiments, the procedures further include identifying, at the network element, each of the plurality of received packets or traffic flows; and generating, for each identified packet or traffic flow, a corresponding TDF identifier. The step of identifying may be performed using deep packet inspection (DPI) of traffic received at the network element. The network elements may be configured to perform a Policy Control Enforcement Function (PCEF).

In various embodiments, the procedures further include receiving, at the network element, policy information from a Policy and Charging Rules Function (PCRF), wherein the service functions are determined in accordance with the policy information. The policy information from the PCRF may comprise one or more Service Function Name References (SFNRs), where each SFNR identifies one or more services to be applied to a respective type of packet or data flow. The SFNR may further identify a sequence for applying each of a plurality of services to the respective type of packet or data flow.

In various embodiments, each of the one or more services identified within the SFNR is associated with a respective bit pattern, and wherein the bit patterns associated with each of a plurality of services is arranged in a manner indicative of a sequence for applying the plurality of services to the respective type of packets or data flow. In various embodiments, a type of packet or data flow may be defined according to one or more of: ingress, egress, application, customer, source, destination, service quality and/or other criteria. In various embodiments, the policy information from the PCRF may comprise a Network Service Chain (NSC) AVP including one or more sub-AVPs defining a network service at the fire, network service position and network service direction.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for associating packets or traffic flows with service functions to be applied thereto, comprising:
determining, by a network element receiving a plurality of packets or traffic flows, a respective service function for each of said plurality of packets or traffic flows, each service function indicative of one or more services to be applied to a respective packet or traffic flow;
adapting, by said network element, a Traffic Data Flow (TDF) identifier of each packet or traffic flow to include data indicative of the respective service function; and
forwarding each packet or traffic flow toward services delivery equipment (SDE).

2. The method of claim 1, further comprising
identifying, at said network element, each of said plurality of received packets or traffic flows; and
generating, for each identified packet or traffic flow, a corresponding TDF identifier.

3. The method of claim 1, wherein said step of identifying is performed using deep packet inspection (DPI) of traffic received at said network element.

4. The method of claim 1, wherein said network element is configured to perform a Policy Control Enforcement Function (PCEF).

5. The method of claim 2, further comprising receiving, at said network element, policy information from a Policy and Charging Rules Function (PCRF), wherein said service functions are determined in accordance with said policy information.

6. The method of claim 5, wherein said policy information from said PCRF comprises one or more Service Function Name References (SFNRs), where each SFNR identifies one or more services to be applied to a respective type of packet or data flow.

7. The method of claim 6, wherein said SFNR further identifies a sequence for applying each of a plurality of services to said respective type of packet or data flow.

8. The method of claim 6, wherein each of said one or more services identified within said SFNR is associated with a respective bit pattern, and wherein the bit patterns associated with each of a plurality of services is arranged in a manner indicative of a sequence for applying said plurality of services to said respective type of packets or data flow.

9. The method of claim 6, wherein a type of packet or data flow may be defined according to one or more of: ingress, egress, application, customer, source, destination and service quality.

10. The method of claim 5, wherein said policy information from said PCRF comprises a Network Service Chain (NSC) AVP providing criteria for determining network services to be applied to packets or data flows.

11. The method of claim 1, further comprising forwarding, by said network element, packets or data flows returned from said SDE toward respective destination addresses.

12. The method of claim 5, further comprising forwarding, toward said PCRF, service charge information associated with said packets or data flows forwarded toward said SDE.

13. The method of claim 5, further comprising:
forwarding, by said network element, packets or data flows returned from said SDE toward respective destination addresses; and
forwarding, toward said PCRF, service charge information associated with said packets or data flows returned from said SDE.

14. The method of claim 5, wherein said service functions are further determined in accordance with Radio Access Network (RAN) congestion information.

15. The method of claim 14, wherein said RAN congestion information is received by said network element via one or both of a command level and a Policy Control and Charging (PCC) level.

16. The method of claim 14, wherein said RAN congestion information defines a plurality of congestion levels suitable, said service functions being adapted in accordance with policies associated with said congestion levels.

17. The method of claim 14, wherein said ran congestion information is included within a Network Services Header (NSH) associated with a packet or traffic flow.

18. An apparatus for associating packets or traffic flows with service functions to be applied thereto, the apparatus comprising:
a processor and a memory, the processor configured for:
determining, by a network element receiving a plurality of packets or traffic flows, a respective service function for each of said plurality of packets or traffic flows, each service function indicative of one or more services to be applied to a respective packet or traffic flow;
adapting, by said network element, a Traffic Data Flow (TDF) identifier of each packet or traffic flow to include data indicative of the respective service function; and
forwarding each packet or traffic flow toward services delivery equipment (SDE).

19. A tangible and non-transient computer readable storage medium storing instructions which, when executed by a computer, adapt the operation of the computer to provide a method for associating packets or traffic flows with service functions to be applied thereto, comprising:
determining, by a network element receiving a plurality of packets or traffic flows, a respective service function for each of said plurality of packets or traffic flows, each service function indicative of one or more services to be applied to a respective packet or traffic flow;
adapting, by said network element, a Traffic Data Flow (TDF) identifier of each packet or traffic flow to include data indicative of the respective service function; and
forwarding each packet or traffic flow toward services delivery equipment (SDE).

20. A computer program product wherein computer instructions, when executed by a processor in a telecom network element, adapt the operation of the telecom network element to provide a method for associating packets or traffic flows with service functions to be applied thereto, comprising:
determining, by a network element receiving a plurality of packets or traffic flows, a respective service function for each of said plurality of packets or traffic flows, each service function indicative of one or more services to be applied to a respective packet or traffic flow;
adapting, by said network element, a Traffic Data Flow (TDF) identifier of each packet or traffic flow to include data indicative of the respective service function; and
forwarding each packet or traffic flow toward services delivery equipment (SDE).
